(19) United States
(12) Patent Application Publication
(10) Pub. No.: US 2013/0238332 A1
(43) Pub. Date: Sep. 12, 2013

(54) AUTOMATIC INPUT SIGNAL RECOGNITION USING LOCATION BASED LANGUAGE MODELING

(71) Applicant: Hong M. Chen, San Jose, CA (US)

(72) Inventor: Hong M. Chen, San Jose, CA (US)

(73) Assignee: Apple Inc., Cupertino, CA (US)

(21) Appl. No.: 13/412,923

(22) Filed: Mar. 6, 2012

(51) Int. Cl. G10L 15/18

(52) U.S. Cl. 704/240; 704/257; 704/E15.018

(57) ABSTRACT

Input signal recognition, such as speech recognition, can be improved by incorporating location-based information. Such information can be incorporated by creating one or more language models that each include data specific to a pre-defined geographic location, such as local street names, business names, landmarks, etc. Using the location associated with the input signal, one or more local language models can be selected. Each of the local language models can be assigned a weight representative of the location's proximity to a pre-defined centroid associated with the local language model. The one or more local language models can then be merged with a global language model to generate a hybrid language model for use in the recognition process.

### BACKGROUND

1. Technical Field

The present disclosure relates to automatic input signal recognition and more specifically to improving automatic input signal recognition by using location based language modeling.

2. Introduction

Input signal recognition technology, such as speech recognition, has drastically expanded in recent years. Its use has expanded from very specific use cases with a limited vocabulary, such as automated telephone answering systems, to say-anything speech recognition. However, as the number and type of possible input signals has broadened, providing accurate results has remained a challenge. This is particularly true for recognition systems that rely on a global language model for all input signals. In such cases, input signals that are unique to a particular geographic region are often improperly recognized.

One solution to this problem can be the creation of local language models in which a particular language model is selected based on the location of the input signal. For example, a service area can be divided into multiple geographic regions and a local language module can be constructed for each region. However, such an approach can result in recognition results skewed in the opposite direction. That is, input signals that are not unique to a particular region may be improperly recognized as a local word sequence because the language model weights local word sequences more heavily. Additionally, such a solution only considers one geographic region, which can still produce inaccurate results if the location is close to the border of the geographic region and the input signal corresponds to a word sequence that is unique in the neighboring geographic region.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The present disclosure describes systems, methods, and non-transitory computer-readable media for automatically recognizing an input signal to produce a word sequence. A method comprises receiving an input signal, such as a speech signal, and an associated location. Based on the location a first local language model is selected. In some configurations, each local language model has an associated pre-defined geo-region. In this case, the local language model is selected by first identifying a geo-region that is a good fit for the location. The geo-region can be selected because the location is contained within the geo-region and/or because the location is within a specified threshold distance of a centroid assigned to the geo-region. The first local language model is then merged with a global language model to generate a hybrid language model. The input signal is recognized based on the hybrid language model by identifying a word sequence that is statistically most likely to correspond to the input signal.

In some configurations, a set of additional local language models can be selected based on the location. Then the first local language model and each language model in the set of additional language models can be merged with the global language model to generate the hybrid language model. Additionally, in some cases, prior to merging, one or more of the local language models can be assigned a weight. The weight can be based on a variety of factors such as the perceived accuracy of the local information used to build the local language model and/or the location's distance from the geo-region's centroid. When a weight is assigned, the weight can be used to influence the merging step.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example system embodiment;

FIG. 2 illustrates an exemplary client-server configuration for location based input signal recognition;

FIG. 3 illustrates an exemplary set of geo-regions;

FIG. 4 illustrates an exemplary speech recognition process;

FIG. 5 illustrates an exemplary location based weighting scheme;

FIG. 6 illustrates an example method embodiment for recognizing an input signal using a single local language model;

FIG. 7 illustrates an example method embodiment for recognizing an input signal using multiple local language models;

FIG. 8 illustrates an exemplary client device configuration for location based input signal recognition; and

FIG. 9 illustrates an example method embodiment for location based input signal recognition on a client device.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The present disclosure addresses the need in the art for improved automatic input signal recognition, such as for speech recognition or auto completion of input from a keyboard. Using the present technology it is possible to improve the recognition results by using information related to the location of the input signal. This is particularly true when the input signal includes a word sequence that globally would have a low probability of occurrence but a much higher probability of occurrence in a particular geographic region. For example, suppose the input signal is the spoken words “goat hill.” Globally this word sequence may have a very low probability of occurrence so the input signal may be recognized as a more common word sequence such as “good will.” However, if the input signal was spoken by someone in a city with a popular café called Goat Hill, then there is a much greater chance the speaker intended the input signal to be recognized as “Goat Hill.” The present technology addresses this deficiency by factoring local information into the recognition process.

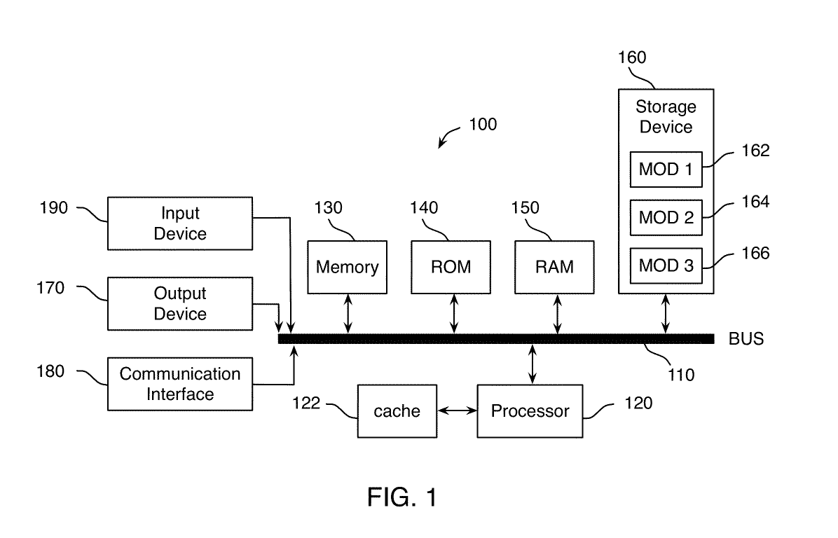

The disclosure first sets forth a discussion of a basic general purpose system or computing device in FIG. 1 that can be employed to practice the concepts disclosed herein before returning to a more detailed description of automatic input signal recognition. With reference to FIG. 1, an exemplary system 100 includes a general-purpose computing device 100, including a processing unit (CPU or processor) 120 and a system bus 110 that couples various system components including the system memory 130 such as read only memory (ROM) 140 and random access memory (RAM) 150 to the processor 120. The system 100 can include a cache 122 connected directly with, in close proximity to, or integrated as part of the processor 120. The system 100 copies data from the memory 130 and/or the storage device 160 to the cache for quick access by the processor 120. In this way, the cache provides a performance boost that avoids processor 120 delays while waiting for data. These and other modules can control or be configured to control the processor 120 to perform various actions. Other system memory 130 may be available for use as well. The memory 130 can include multiple different types of memory with different performance characteristics. It can be appreciated that the disclosure may operate on a computing device 100 with more than one processor 120 or on a group or cluster of computing devices networked together to provide greater processing capability. The processor 120 can include any general purpose processor and a hardware module or software module, such as module 1 162, module 2 164, and module 3 166 stored in storage device 160, configured to control the processor 120 as well as a special-purpose processor where software instructions are incorporated into the actual processor design. The processor 120 may essentially be a completely self-contained computing system, containing multiple cores or processors, a bus, memory controller, cache, etc. A multi-core processor may be symmetric or asymmetric.

The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices 160 such as a hard disk drive, a magnetic disk drive, an optical disk drive, tape drive or the like. The storage device 160 can include software modules 162, 164, 166 for controlling the processor 120. Other hardware or software modules are contemplated. The storage device 160 is connected to the system bus 110 by a drive interface. The drives and the associated computer readable storage media provide nonvolatile storage of computer readable instructions, data structures, program modules and other data for the computing device 100. In one aspect, a hardware module that performs a particular function includes the software component stored in a non-transitory computer-readable medium in connection with the necessary hardware components, such as the processor 120, bus 110, display 170, and so forth, to carry out the function. The basic components are known to those of skill in the art and appropriate variations are contemplated depending on the type of device, such as whether the device 100 is a small, handheld computing device, a desktop computer, or a computer server.

Although the exemplary embodiment described herein employs the hard disk 160, it should be appreciated by those skilled in the art that other types of computer readable media which can store data that are accessible by a computer, such as magnetic cassettes, flash memory cards, digital versatile disks, cartridges, random access memories (RAMs) 150, read only memory (ROM) 140, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 100, an input device 190 represents any number of input mechanisms, such as a microphone for speech, a touch-sensitive screen for gesture or graphical input, keyboard, mouse, motion input, speech and so forth. An output device 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 120. The functions these blocks represent may be provided through the use of either shared or dedicated hardware, including, but not limited to, hardware capable of executing software and hardware, such as a processor 120, that is purpose-built to operate as an equivalent to software executing on a general purpose processor. For example the functions of one or more processors presented in FIG. 1 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 140 for storing software performing the operations discussed below, and random access memory (RAM) 150 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 100 shown in FIG. 1 can practice all or part of the recited methods, can be a part of the recited systems, and/or can operate according to instructions in the recited non-transitory computer-readable storage media. Such logical operations can be implemented as modules configured to control the processor 120 to perform particular functions according to the programming of the module. For example, FIG. 1 illustrates three modules Mod1 162, Mod2 164 and Mod3 166 which are modules configured to control the processor 120. These modules may be stored on the storage device 160 and loaded into RAM 150 or memory 130 at runtime or may be stored as would be known in the art in other computer-readable memory locations.

Before disclosing a detailed description of the present technology, the disclosure turns to a brief introductory description of how an arbitrary input signal, such as a speech signal, can be recognized to generate a word sequence. The introductory description discloses a recognition process based on statistical language modeling. However, a person skilled in the relevant art will recognize that alternative language modeling techniques can also be used.

In automatic input signal recognition, such as speech recognition or auto completion of input from a keyboard, an input signal is received and a language model can be used to identify the word sequence that most likely corresponds to the input signal. For example, in automatic speech recognition a language model can be used to translate an acoustic signal into the word sequence most likely to have been spoken.

A language model used in input signal recognition can be designed to capture the properties of a language. One common language modeling technique used to translate an input signal into a word sequence is statistical language modeling. In statistical language modeling, the language model is built by analyzing large samples of the target language to generate a probability distribution, which can then be used to assign a probability to a sequence of m words: P(w₁, . . . , wₘ). Using a statistical language model, an input signal can then be mapped to one or more word sequences. The word sequence with the greatest probability of occurrence can then be selected. For example, an input signal may be mapped to the word sequences “good will,” “good hill,” “goat hill,” and “goat will.” If the word sequence “good will” has the greatest probability of occurrence, “good will” will be the output of the recognition process.

A person skilled in the relevant art will recognize that while the disclosure frequently uses speech recognition to illustrate the present technology, the recognition process can be applied to a variety of different input signals. For example, the present technology can also be used in information retrieval systems to suggest keyword search terms or for auto completion of input from a keyboard. For example, the present technology can be used in auto completion to rank local points of interest higher in the auto completion list.

Having disclosed an introductory description of how an arbitrary input signal can be recognized to generate a word sequence using a statistical language model, the disclosure now returns to a discussion of automatically recognizing an input signal using location based language modeling. A person skilled in the relevant art will recognize that while the disclosure uses a statistical language model to illustrate the recognition process, alternative language models are also possible without parting from the spirit and scope of the art.

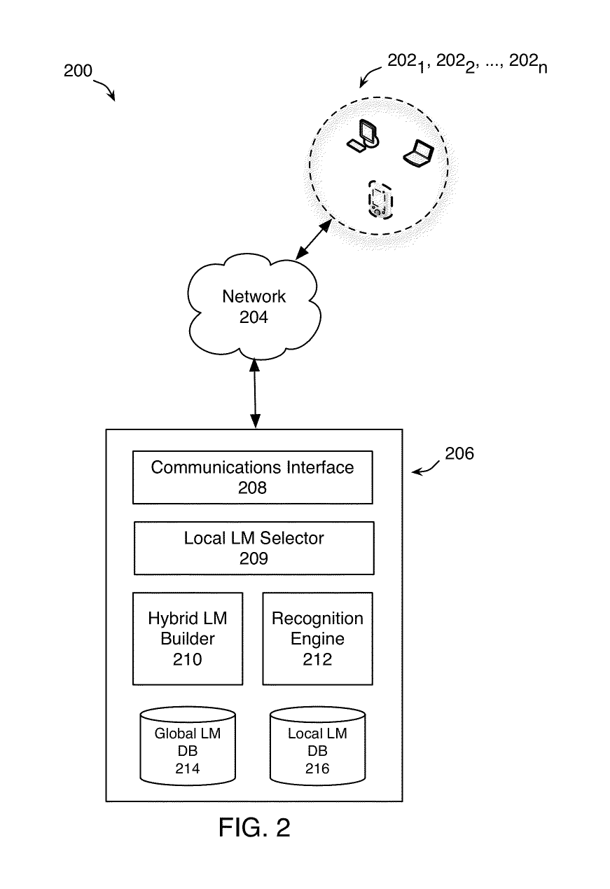

FIG. 2 illustrates an exemplary client-server configuration 200 for location based input signal recognition. In the exemplary client-server configuration 200, the recognition system 206 can be configured to reside on a server, such as a general-purpose computing device like system 100 in FIG. 1.

In system configuration 200, a recognition system 206 can communicate with one or more client devices 202₁, 202₂, . . . , 202ₙ (collectively “202”) connected to a network 204 by direct and/or indirect communication. The recognition system 206 can support connections from a variety of different client devices, such as desktop computers; mobile computers; handheld communications devices, e.g. mobile phones, smart phones, tablets; and/or any other network enabled communications devices. Furthermore, recognition system 206 can concurrently accept connections from and interact with multiple client devices 202.

Recognition system 206 can receive an input signal from client device 202. The input signal can be any type of signal that can be mapped to a representative word sequence. For example, the input signal can be a speech signal for which the recognition system 206 can generate a word sequence that is statistically most likely to represent the input speech signal. Alternatively, the input sequence can be a text sequence. In this case, the recognition system can be configured to generate a word sequence that is statistically most likely to complete the input text signal received, e.g. the input text signal could be “good” and the generated word sequence could be “good day.”

Recognition system 206 can also receive a location associated with the client device 202. The location can be expressed in a variety of different formats, such as latitude and/or longitude, GPS coordinates, zip code, city, state, area code, etc. A variety of automated methods for identifying the location of the client device 202 are possible, e.g. GPS, triangulation, IP address, etc. Additionally, in some configurations, a user of the client device can enter a location, such as the zip code, city, state, and/or area code, representing where the client device 202 is currently located. Furthermore, in some configurations, a user of the client device can set a default location for the client device such that the default location is either always provided in place of the current location or is provided when the client device is unable to determine the current location. The location can be received in conjunction with the input signal, or it can be obtained through other interaction with the client device 202.

Recognition system 206 can contain a number of components to facilitate the recognition of the input signal. The components can include one or more databases, e.g. a global language model database 214 and a local language model database 216, and one or more modules for interacting with the databases and/or recognizing the input signal, e.g. the communications interface 208, the local language model selector 209, the hybrid language model builder 210, and the recognition engine 212. It should be understood to one skilled in the art, that the configuration illustrated in FIG. 2 is simply one possible configuration and that other configurations with more or less components are also possible.

In the exemplary configuration 200 in FIG. 2, the recognition system 206 maintains two databases. The global language model database 214 can include one or more global language models. As described above, a language model is used to capture the properties of a language and can be used to translate an input signal into a word sequence or predict a word sequence. A global language model is designed to capture the general properties of a language. That is, the model is designed to capture universal word sequences as opposed to word sequences that may have an increased probability of occurrence in a segment of the population or geographic region. For example, a global language model can be built for the English language that captures word sequences that are widely used by the majority of English speakers. Because a language model is used to capture the properties of a language, in some configurations, the global language model database 214 can maintain different language models for different languages, e.g. English, Spanish, French, Japanese, etc., and can be built using a variety of sample local texts including phonebooks, yellowpages, local newspapers, blogs, maps, local advertisements, etc.

The local language model database 216 can include one or more local language models. A local language model can be designed to capture word sequences that may be unique to a particular geographic region. Each local language model can be created using local information, such as local street names, business names, neighborhood names, landmark names, attractions, culinary delicacies, etc.

Each local language model can be associated with a pre-defined geographic region, or geo-region. Geo-regions can be defined in a variety of ways. For example, geo-regions can be based on well-established geographic regions such as zip code, area code, city, county, etc. Alternatively, geo-regions can be defined using arbitrary geographic regions, such as by dividing a service area into multiple geo-regions based on distribution of users. Additionally, geo-regions can be defined to be overlapping or mutually exclusive. Furthermore, in some configurations, there can be gaps between geo-regions. That is, areas that are not part of a geo-region.

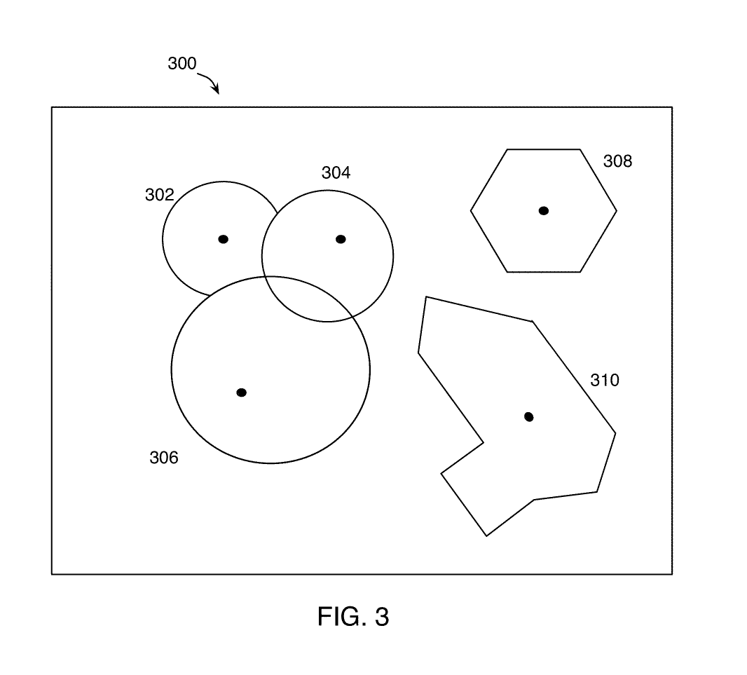

FIG. 3 illustrates an exemplary set of geo-regions 300. The exemplary set of geo-regions 300 can include multiple geo-regions, which as illustrated in FIG. 3, can be of differing sizes, e.g. geo-regions 304 and 306, and shapes, e.g. geo-regions 302, 304, 308, and 310. Additionally, the geo-regions can be overlapping, such as illustrated by geo-regions 304 and 306. Furthermore, there can be gaps between the geo-regions such that there are areas not covered by a geo-region. For example, if a received location is between geo-regions 304 and 308, then it is not contained in a geo-region.

Each geo-region can be associated with or contain a centroid. A centroid can be a pre-defined focal point of a geo-region defined by a location. The centroid's location can be selected in a number of different ways. For example, the centroid's location can be the geographic center of the location. Alternatively, the centroid's location can be defined based on a city center, such as city hall. The centroid's location can also be based on the concentration of the information used to build the local language model. That is, if the majority of the information is heavily concentrated around a particular location, that location can be selected as the centroid. Additional methods of positioning a centroid are also possible, such as population distribution.

Returning to FIG. 2, it should be understood to one skilled in the art that the recognition system 206 can be configured with more or less databases. For example, the global language model(s) and local language models can be maintained in a single database. Alternatively, the recognition system 206 can be configured to maintain a database for each language supported where the individual databases contain both the global language model and all of the local language models for that language. Additional methods of distributing the global and local language models are also possible.

In the exemplary configuration in FIG. 2, the recognition system 206 maintains four modules for interacting with the databases and/or recognizing the input signal. The communications interface 208 can be configured to receive an input signal and associated location from client device 202. After receiving the input signal and location, the communications interface can send the input signal and location to other modules in the recognition system 206 so that the input signal can be recognized.

The recognition system 206 can also maintain a local language model selector 209. The local language module selector 209 can be configured to receive the location from the communications interface 208. Based on the location, the local language model selector 209 can select one or more local language models that can be passed to the hybrid language model builder 210. The hybrid language model builder 210 can merge the one or more local language models and a global language model to produce a hybrid language model. Finally, the recognition engine 212 can receive the hybrid language model built by the hybrid language model builder 210 to recognize the input signal.

As described above, one aspect of the present technology is the gathering and use of location information. The present disclosure recognizes that the use of location-based data in the present technology can be used to benefit the user. For example, the location-based data can be used to improve input signal recognition results. The present disclosure further contemplates that the entities responsible for the collection and/or use of location-based data should implement and consistently use privacy policies and practices that are generally recognized as meeting or exceeding industry or government requirements for maintaining location-based data private and secure. For example, location-based data from users should be collected for legitimate and reasonable uses of the entity and not shared or sold outside of those legitimate uses. Further, such collection should occur only after the informed consent of the users. Additionally, such entities should take any needed steps for safeguarding and securing access to such location-based data and ensuring that others with access to the location-based data adhere to their privacy and security policies and procedures. Further, such entities can subject themselves to evaluation by third parties to certify their adherence to widely accepted privacy policies and practices.

Despite the foregoing, the present disclosure also contemplates embodiments in which users selectively block the use of, or access to, location-based data. That is, the present disclosure contemplates that hardware and/or software elements can be provided to prevent or block access to such location-based data. For example, the present technology can be configured to allow users to select to “opt in” or “opt out” of participation in the collection of location-based data during registration for the service or through a preferences setting. In another example, users can specify the granularity of location information provided to the input signal recognition system, e.g. the user grants permission for the client device to transmit the zip code, but not the GPS coordinates.

Therefore, although the present disclosure broadly covers the use of location-based data to implement one or more various disclosed embodiments, the present disclosure also contemplates that the various embodiments can also be implemented using varying granularities of location-based data. That is, the various embodiments of the present technology are not rendered inoperable due to a lack of granularity of location-based data.

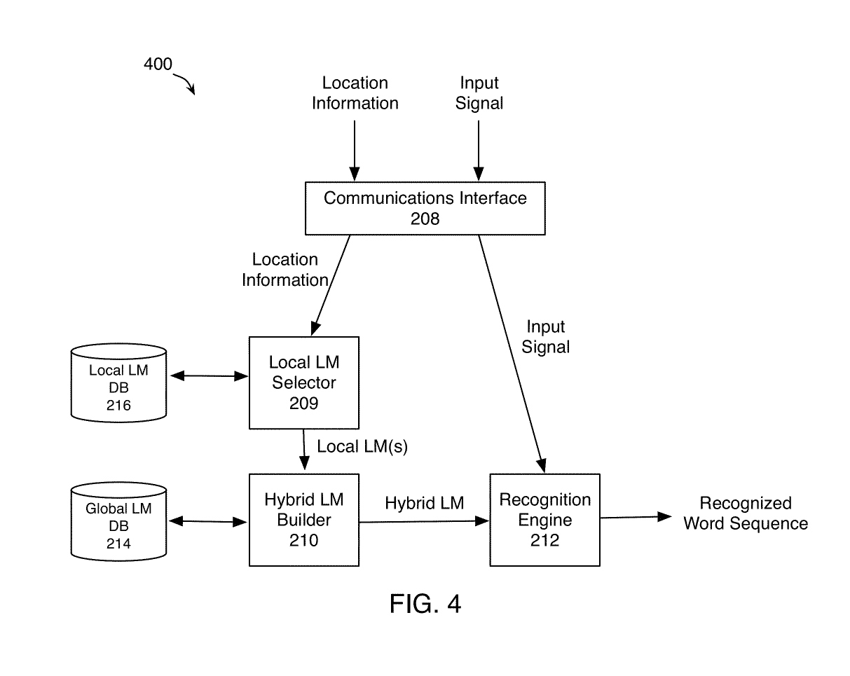

FIG. 4 illustrates an exemplary input signal recognition process 400 based on recognition system 206. As described above, the communications interface 208 can be configured to receive an input signal and an associated location. The communications interface 208 can pass the location information along to the local language model selector 209.

The local language model selector 209 can be configured to receive the location from the communications interface 208. Based on the location, the local language selector can identify a geo-region. A geo-region can be selected in a variety of ways. In some cases, a geo-region can be selected based on location containment. That is, a geo-region can be selected if the location is contained within the geo-region. Alternatively, a geo-region can be selected based on location proximity. For example, a geo-region can be selected if the location is closest to the geo-region's centroid. In cases where multiple geo-regions are equally viable, such as when geo-regions overlap or the location is equidistant from two different centroids, tiebreaker policies can be established. For example, if a location is contained within more than one geo-region, proximity to the centroid or the closest boundary can be used to break the tie. Likewise, when a location is equidistant from multiple centroids, containment or distance from a boundary can be used as the tiebreaker. Alternative tie breaking methods are also possible. Once the local language model selector 209 has selected a geo-region, the local language model selector 209 can obtain the corresponding local language model, such as by fetching it from the local language model database 216.

In some embodiments, the local language model selector 209 can be configured to select additional geo-regions. For example, the local language selector 209 can be configured to select all geo-regions that the location is contained within and/or all geo-regions where the location is within a threshold distance of the geo-region's centroid. In such configurations, the local language model selector 209 can also obtain the corresponding local language model for each additional geo-region.

The local language model selector 209 can also be configured to assign a weight or scaling factor to one or more of the selected local language models. In some cases, only a subset of the local language models will be assigned a weight. For example, if geo-regions were selected both based on containment and proximity, the local language model selector 209 can assign a weight designed to decrease the contribution of the local language models corresponding to geo-regions selected based on proximity. That is, local language models that correspond to geo-regions that are further away can be given a weight, such as a fractional weight, that results in those local language models having less significance. Alternatively, the local language model selector 209 can be configured to assign a weight to a language model if the location's distance from the associated geo-region's centroid exceeds a specified threshold. Again, the weight can be designed to decrease the contribution of the local language model. In this case, the weight can be assigned regardless of location containment within a geo-region. Additional methods of selecting a subset of the local language models that will be assigned a weight or scaling factor are also possible.

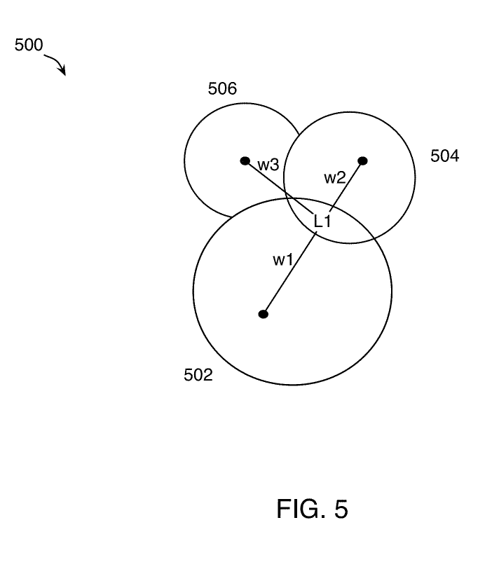

In some configurations, the weight can be based on the location's distance from the associated geo-region's centroid. For example, FIG. 5 illustrates an exemplary weighting scheme 500 based on distance from a centroid. In this example, three geo-regions, 502, 504, and 506, have been selected for the location L1. Even though location L1 is contained within reo-regions 502 and 504, a weight is assigned to each of the corresponding local language models. Weight w1 is assigned to the local language model associated with geo-region 502, weight w2 is assigned to the local language model associated with geo-region 504, and weight w3 is assigned to the local language model associated with geo-region 506.

Using the weighting scheme 500 illustrated in FIG. 5, if the location is further from the centroid, the local language model can be assigned a lower weight. For example, the weight can be inversely proportional to the distance from the centroid. This is based on the idea that if the location is further away, the input signal is less likely to correspond with unique word sequences from that geo-region. Alternatively, the weight can be some other function of the distance from the centroid. For example, machine learning techniques can be used to determine an optimal function type and any parameters for the function.

The weight can also be based, at least in part, on the perceived accuracy of the local information used to build the local language model. For example, if the information is compiled from reputable sources such as government documents or phonebook and yellowpage listings, the local language model can be given a higher weight than one compiled from less reputable sources, such as blogs. Additional weighting schemes are also possible.

Returning to FIG. 4, the local language model selector 209 can pass the one or more local language models, with any associated weights, to the hybrid language model builder 210. The hybrid language model builder 210 can be configured to obtain a global language model such as from the global language model database 214. The hybrid language model builder 210 can then merge the global language model and the one or more local language models to generate a hybrid language model. In some embodiments, the merging can be influenced by one or more weights associated with one or more local language models. For example, a hybrid language model (HLM) generated based on location L1 in FIG. 5 can be merged such that

HLM=GLM+(w₁*LLM₁)+(w₂*LLM₂)+(w₃*LLM₃)

where GLM is the global language model, LLM₁ is the local language model associated with geo-region 502, LLM₂ is the local language model associated with geo-region 504, and LLM₃ is the local language model associated with geo-region 506.

Once the hybrid language model builder 210, in FIG. 4, generates a hybrid language model, the hybrid language model can be passed to the recognition engine 212. The recognition engine 212 can also receive the input signal from the communications interface 208. The recognition engine 212 can use the hybrid language model to generate a word sequence corresponding to the input signal. As described above, the hybrid language model can be a statistical language model. In this case, the recognition engine 212 can use the hybrid language model to identify the word sequence that is statistically most likely to correspond to the input sequence.

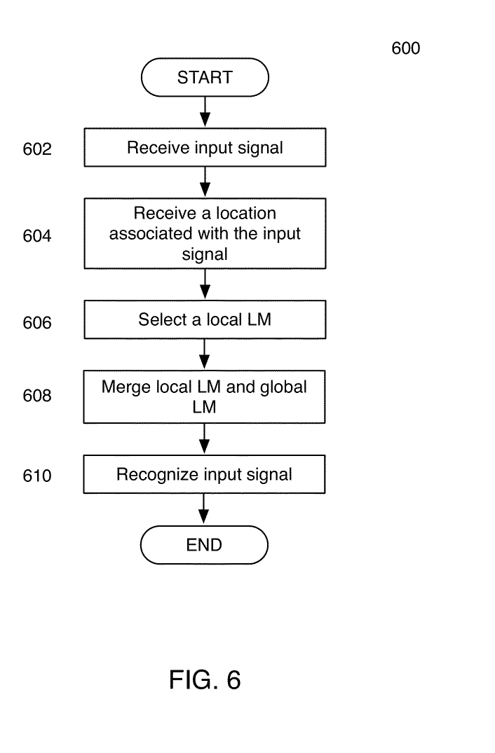

FIG. 6 is a flowchart illustrating an exemplary method 600 for automatically recognizing an input signal using a single local language model. For the sake of clarity, this method is discussed in terms of an exemplary recognition system such as is shown in FIG. 2. Although specific steps are shown in FIG. 6, in other embodiments a method can have more or less steps than shown. The automatic input signal recognition process 600 begins at step 602 where the recognition system receives an input signal. In some configurations, the input signal can be a speech signal. The recognition system can also receive a location associated with the input signal (604), such as GPS coordinates, city, zip code, etc. In some configurations, the location can be received in conjunction with the input signal. Alternatively, the location can be received through other interaction with a client device.

Once the recognition system has received the input signal and the associated location, the recognition system can select a local language model based on the location (606). In some configurations, the recognition system can select a local language model by first identifying a geo-region that is a good fit for the location. In some cases, the geo-region can be identified based on the location's containment within the geo-region. Alternatively, a geo-region can be selected based on the location's proximity to the geo-region's centroid. In cases where multiple geo-regions are equally viable options, a tiebreaker method can be employed, such as those discussed above. Once a geo-region has been identified, the corresponding local language model can be selected. In some configurations, the local language model can be a statistical language model.

The selected local language model can then be merged with a global language model to generate a hybrid language model (608). In some configurations, the merging process can incorporate a local language model weight. That is, a weight can be assigned to the local language model that is used to indicate how much influence the local language model should having in the generated hybrid language model. The assigned weight can be based on a variety of factors, such as the perceived accuracy of the local language model and/or the location's proximity to the geo-region's centroid. The hybrid language model can then be used to recognize the input signal (610) by identifying the word sequence that is most likely to correspond to the input signal.

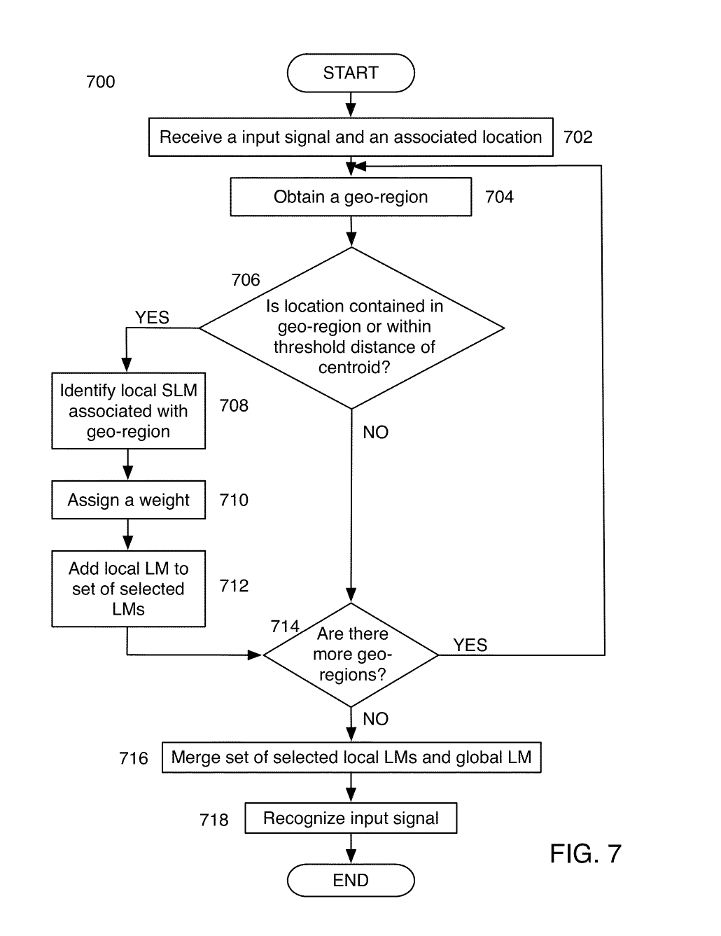

FIG. 7 is a flowchart illustrating an exemplary method 700 for automatically recognizing an input signal using multiple local language models. For the sake of clarity, this method is discussed in terms of an exemplary recognition system such as is shown in FIG. 2. Although specific steps are shown in FIG. 7, in other embodiments a method can have more or less steps than shown. The automatic input signal recognition process 700 begins at step 702 where the recognition system receives an input signal and an associated location. In some configurations, the input signal and associated location can be received as a pair in a single communication with the client device. Alternatively, the input signal and associated location can be received through separate communications with the client device.

After receiving the input signal and associated location, the recognition system can obtain a geo-region (704) and check if the location is contained within the geo-region or within a specified threshold distance of the geo-region's centroid (706). If so, the recognition system can obtain the local language model associated with the geo-region (708) and assign a weight (710) to the local language model. In some configurations, the weight can be based on the location's distance from the geo-region's centroid. The weight can also be based, at least in part, on the perceived accuracy of the local information used to build the local language model. In some configurations, the recognition system can assign a weight to only a subset of the local language models. In some cases, whether a local language model is assigned a weight can be based on the type of weight. For example, if the weight is based on perceived accuracy, a local language model may not be assigned a weight if the level of perceived accuracy is above a specified threshold value. Alternatively, the recognition system can be configured to assign a distance weight only if the location is outside of the geo-region associated with the local language model. In this case, the distance weight can be based on the distance between the location and the geo-region's centroid. The recognition system can then add the local language model and it associated weight to the set of selected local language models (712).

After processing a single geo-region, the recognition process can continue by checking if there are additional geo-regions (714). If so, the local language model selection process repeats by continuing at step 704. Once all of the local language models corresponding to the location have been identified, the recognition system can merge the set of selected local language models with a global language model (716) to generate a hybrid language model. The merging can be influenced by the weights associated with the local language models. In some cases, a local language model with less reliable information and/or that is associated with a more distant geo-region can have less of a statistical impact on the generated hybrid language model.

The recognition system can then recognize the input signal (718) by translating the input signal into a word sequence based on the hybrid language model. In some configurations, the hybrid language model is a statistical language model and thus the input signal can be translated by identifying the word sequence in the hybrid language model that has the highest probability of corresponding to the input signal.

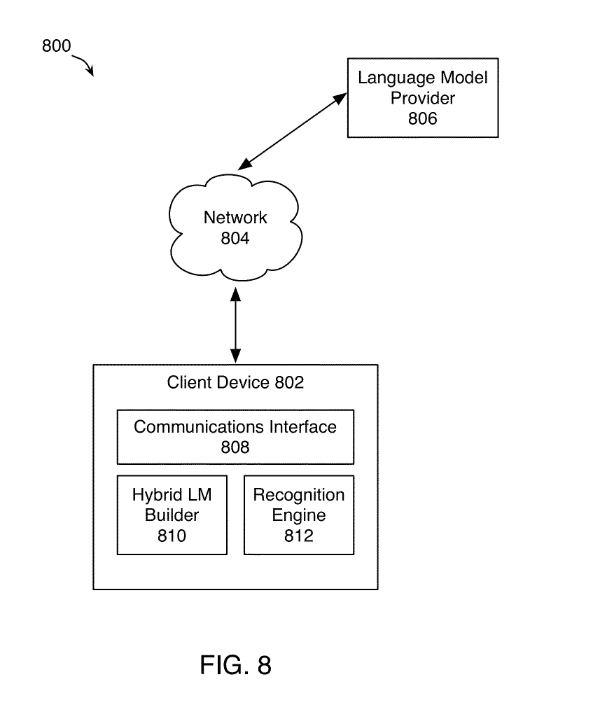

FIG. 8 illustrates an exemplary client device configuration for location based input signal recognition. Exemplary client device 802 can be configured to reside on a general-purpose computing device, such as system 100 in FIG. 1. Client device 802 can be any network enabled computing, such as a desktop computer; a mobile computer; a handheld communications device, e.g. mobile phone, smart phone, tablet; and/or any other network enable communications device.

Client device 802 can be configured to receive an input signal. The input signal can be any type of signal that can be mapped to a representative word sequence. For example, the input signal can be a speech signal for which the client device 802 can generate a word sequence that is statistically most likely to represent the input speech signal. Alternatively, the input sequence can be a text sequence. In this case, the client device can be configured to generate a word sequence that is statistically most likely to complete the input text signal received or be equivalent to the text signal received.

The manner in which the client device 802 receives the input signal can vary with the configuration of the device and/or the type of the input signal. For example, if the input signal is a speech signal, the client device 802 can be configured to receive the input signal via a microphone. Alternatively, if the input signal is a text signal, the client device 802 can be configured to receive the input signal via a keyboard. Additional methods of receiving the input signal are also possible.

Client device 802 can also receive a location representative of the location of the client device. The location can be expressed in a variety of different formats, such as latitude and/or longitude, GPS coordinates, zip code, city, state, area code, etc. The manner in which the client device 802 receives the location can vary with the configuration of the device. For example, a variety of methods for identifying the location of a client device are possible, e.g. GPS, triangulation, IP address, etc. In some cases, the client device 802 can be equipped with one or more of these location identification technologies. Additionally, in some configurations, a user of the client device can enter a location, such as the zip code, city, state, and/or area code, representing the current location of the client device 802. Furthermore, in some configurations, a user of the client device 802 can set a default location for the client device such that the default location is either always provided in place of the current location or is provided when the client device is unable to determine the current location.

The client device 802 can be configured to communicate with a language model provider 806 via network 804 to receive one or more local language models and a global language model. As disclosed above, a language model can be any model that can be used to capture the properties of a language for the purpose of translating an input signal into a word sequence. In some configurations, the client device 802 can communicate with multiple language model providers. For example, the client device 802 can communicate with one language model provider to receive the global language model and another to receive the one or more local language models. Alternatively, the client device 802 can communicate with different language providers depending on the device's locations. For example, if the client device 802 moves from one geographic region to another, the client device may receive the language models from different language model providers.

The client device 802 can contain a number of components to facilitate the recognition of the input signal. The components can include one or more modules for interacting with a language model provider and/or recognizing the input signal, e.g. the communications interface 808, the hybrid language model builder 810, and the recognition engine 812. It should be understood to one skilled in the art, that the configuration illustrated in FIG. 8 is simply one possible configuration and that other configurations with more or less components are also possible.

The communications interface 808 can be configured to communicate with the language model provider 806 to make requests to the language model provider 806 and receive the requested language models. As described above, each local language model can be associated with a pre-defined geographic region, or geo-region. A geo-region can be defined in a variety of ways. For example, geo-regions can be based on well-established geographic regions such as zip code, area code, city, county, etc. Alternatively, geo-regions can be defined using arbitrary geographic regions, such as by dividing a service area into multiple geo-regions based on distribution of users. Additionally, geo-regions can be defined to be overlapping or mutually exclusive. Furthermore, in some configurations, there can be gaps between geo-regions.

Additionally, as described above, each geo-region can be associated with or contain a centroid. A centroid can be a pre-defined focal point of a geo-region defined by a location. The centroid's location can be selected in a number of different ways. For example, the centroid's location can be the geographic center of the location. Alternatively, the centroid's location can be defined based on a city center, such as city hall. The centroid's location can also be based on the concentration of the information used to build the local language model. That is, if the majority of the information is heavily concentrated around a particular location, that location can be selected as the centroid. Additional methods of positioning a centroid are also possible, such as population distribution.

In some configurations, the client device 802 can identify a geo-region for the location. In this case, when the client device 802 requests a local language model from the language model provider 806, the request can include a geo-region identifier. Alternatively, the client device 802 can be configured to send the location along with the request and the language model provider 806 can identified an appropriate geo-region. In some configurations, the client device 802 can receive a centroid along with the local language model. The centroid can be the centroid for the geo-region associated with the local language model.

In some configurations, a received local language model can also have an associated weight. The type of weight can vary with the configuration. For example, in some cases, the weight can be based, at least in part, on the perceived accuracy of the local information used to build the local language model. In such configurations where the client device supplied the location with the request, the weight can be based on the location's distance from the geo-region's centroid. Alternatively, a distance or proximity based weight can be calculated by the client device using the location and the centroid associated with the client selected geo-region or the centroid received with the local language model. In some configurations, only a subset of the local language models will be assigned a weight. In some cases, whether a local language model is assigned a weight can be based on the type of weight. For example, if the weight is based on perceived accuracy, a local language model may not be assigned a weight if the level of perceived accuracy is above a specified threshold value. Alternatively, a local language may only be assigned a distance weight if the location is outside of the geo-region associated with the local language model.

The communications interface 808 can be configured to pass the received global language model and the one or more local language models to the hybrid language model builder 810. The hybrid language model builder 810 can be configured to merge the global language model and the one or more local language models to generate a hybrid language model. In some embodiments, the merging can be influenced by one or more weights associated with one or more local language models. Once the hybrid language model builder 810 generates a hybrid language model, the hybrid language model can be passed to the recognition engine 812. The recognition engine can use the hybrid language model to generate a word sequence corresponding to the input signal. As described above, the hybrid language model can be a statistical language model. In this case, the recognition engine 812 can use the hybrid language model to identify the word sequence that is statistically most likely to correspond to the input sequence.

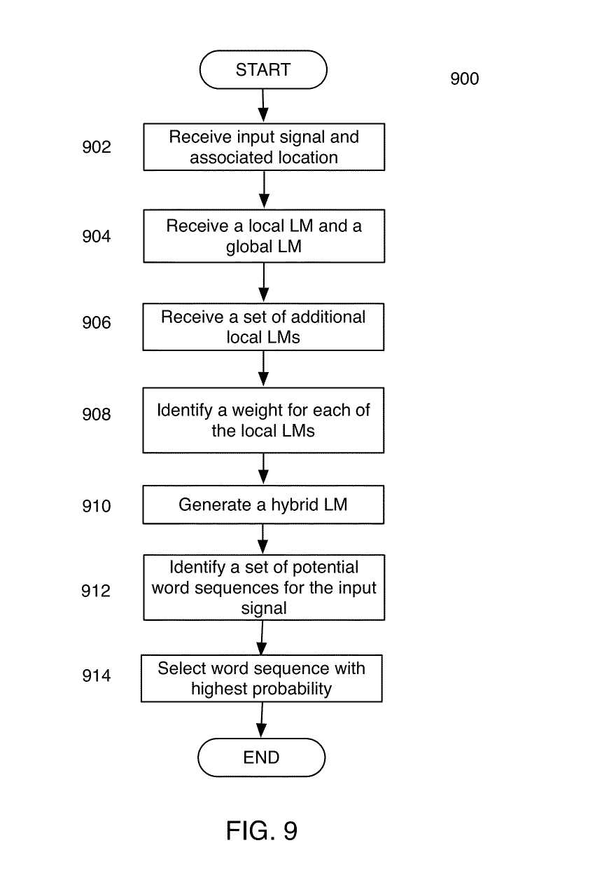

FIG. 9 is a flowchart illustrating an exemplary method 900 for automatically recognizing an input signal. For the sake of clarity, this method is discussed in terms of an exemplary client device such as is shown in FIG. 8. Although specific steps are shown in FIG. 9, in other embodiments a method can have more or less steps than shown. The automatic input signal recognition method 900 begins at step 902 where the client device receives an input signal and an associated location. In some configurations the input signal can be a speech signal.

Once the client device has received the input signal and associated location, the client device can receive a local language model and a global language model (904) in response to a request. In some configurations, the request can include the location. Alternatively, the request can include a geo-region that the client device has identified as being a good fit for the location. In some configurations, the received local language model can have an associated geo-region centroid.

The client device can also receive a set of additional local language models (906) in response to a request for local language models. In some configurations, this request can be separate from the original request. Alternatively, the client device can make a single request for a set of local language models and a global language model. As with the originally received local language model, each of the local language models in the set of additional local language models can have an associated geo-region centroid.

After receiving the one or more local language models, the client device can identify a weight for each of the local language models (908). In some configurations, a weight can be assigned by the language model provider and thus the client device simply needs to detect the weight. However, in other cases, the client device can calculate a weight. In some configurations, the weight can be based on the distance between the location and the associated centroid. Additionally, in some cases, the calculated weight can incorporate a weight already associated with the local language model, such as a perceived accuracy weight.

The one or more local language models can then be merged with the global language model to generate a hybrid language model (910). In some configurations, the merging can be influenced by the weights associated with the local language models. For example, a local language model with less reliable information and/or that is associated with a more distant geo-region can have less of a statistical impact on the generated hybrid language model.

Using the statistical language model, the client device can identify a set of word sequences that could potentially correspond to the input signal (912). In some configurations, the hybrid language model is a statistical language model and thus each potential word sequence can have an associated probability of occurrence. In this case, the client device can recognize the input signal by selecting the word sequence with the highest probably of occurrence (914).

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure.

We claim:

1. A computer implemented method for input signal recognition, the method comprising:
receiving an input signal and a location associated with the input signal;
selecting a first language model from a plurality of local language models based on the location;
merging, via a processor, the first local language model and a global language model to generate a hybrid language model; and
recognizing the input signal based on the hybrid language model by identifying a word sequence that is statistically most likely to correspond to the input signal.

2. The method of claim 1, wherein the input signal is a speech signal.

3. The method of claim 1, wherein the first local language model is mapped to a geo-region that is associated with the location, the geo-region containing a centroid.

4. The method of claim 3, wherein the location is contained within the geo-region.

5. The method of claim 3, wherein the location is within a specified threshold distance of the centroid.

6. The method of claim 3, further comprising selecting a second local language model from the plurality of local language models based on the location, and further including merging the first local language model, the second local language model, and the global language model to generate the hybrid language model.

7. The method of claim 6, further including prior to merging the first local language model, the second local language model, and the global language model, assigning a first weight value to the first local language model and a second weight value to the second local language model.

8. The method of claim 7, wherein a weight value is based at least in part on the location's distance from a centroid contained within a selected geo-region.

9. The method of claim 7, wherein a weight value is based at least in part on an accuracy level assigned to a local language model.

10. The method of claim 1, wherein the first local language model includes at least one of a local street name, a local neighborhood name, a local business name, a local landmark name, and a local attraction name.

11. The method of claim 3, wherein the geo-region is defined by an established geographic location.

12. A system for input signal recognition comprising:
a server;
receiving at the server, an input signal and a location associated with the input signal;
generating a hybrid language model by incorporating a first local language model into a global language model, the first local language model corresponding to the location; and
selecting a word sequence using the hybrid language model, wherein the word sequence has the greatest probability of corresponding to the input signal.

13. The system of claim 12, wherein the first local language model corresponds to the location by way of a geo-region, the geo-region having a centroid.

14. The system of claim 13, further comprising incorporating a second local language model into the global language model to generate the hybrid language model, the second local language model also corresponding to the location.

15. The system of claim 14, further comprising:
prior to incorporating the first local language model and the second local language model into the global language model, assigning a first scaling factor to the first local language model and a second scaling factor to the second local language model; and
generating the hybrid language model by incorporating the first local language model and the second local language model into the global language model based on the respective first and second scaling factors.

16. The system of claim 15, wherein a scaling factor is applied to a local language model when the location is outside of a geo-region associated with the language model.

17. The system of claim 13, wherein the location is contained within the geo-region.

18. The system of claim 13, wherein the location is within a specified threshold distance of the centroid.

19. A non-transitory computer-readable storage medium storing instructions which, when executed by a computing device, cause the computing device to recognize an input signal, the instructions comprising:
receiving an input signal and a location associated with the input signal;
obtaining a first local language model and a global language model, the first local language model based on a location;
generating a hybrid language model by merging the first local language model and the global language model; and
recognizing the input signal by identifying a set of potential word sequences for the input signal, each word sequence having an associated probability of occurrence, and selecting the word sequence with the highest probability.

20. The non-transitory computer-readable storage medium of claim 19, the instructions further comprising obtaining a second local language model based on the location, and further including merging the first local language model, the second local language model, and the global language model to generate the hybrid language model.

21. The non-transitory computer-readable storage medium of claim 20, the instructions further comprising:
prior to merging the first local language model, the second local language model, and the global language model, assigning a first weight to the first local language model and a second weight to the second local language model; and
generating the hybrid language model by merging the first local language model, the second local language model, and the global language model, wherein the merging is influenced by the first and second weights.

22. The non-transitory computer-readable storage medium of claim 19, wherein the first local language model is associated with a pre-defined geo-region, the geo-region containing a centroid.

23. The non-transitory computer-readable storage medium of claim 22, wherein the location is contained within the geo-region associated with the first local language model.

24. The non-transitory computer-readable storage medium of claim 22, wherein the location is within a specified threshold distance of the centroid contained within the geo-region associated with the first local language model.

25. The non-transitory computer-readable storage medium of claim 21, wherein a local language model is a statistical language model, the statistical language model built using at least one of a local phonebook, a local yellowpages listings, a local newspaper, a local map, a local advertisement, and a local blog.
